(19) United States
(12) Patent Application Publication
(10) Pub. No.: US 2022/0039516 A1
(43) Pub. Date: Feb. 10, 2022

(54) Footwear Insert and Method of Manufacture

(71) Applicant: Ashley Miller, Greeley, CO (US)

(72) Inventor: Ashley Miller, Greeley, CO (US)

(21) Appl. No.: 17/210,706

(22) Filed: Mar. 24, 2021

Related U.S. Application Data
(60) Provisional application No. 63/063,905, filed on Aug. 10, 2020.

(51) Int. Cl. A43B 17/00; B29D 35/14

(52) U.S. Cl. CPC A43B 17/006; B29D 35/142

(57) ABSTRACT

An insole for insertion into an article of footwear to alleviate foot pain and a related method of manufacture is disclosed. The multi-layer insole comprises a top layer, a textured layer and a bottom layer. The top layer having first and second impression portions, wherein the first impression conforms to the muscle anatomy and the second impression conforms to the tendon anatomy of the plantar side of the user's foot. The bottom layer having a third impression portion that conforms to a user's skeletal anatomy on the plantar side of the foot. A method of forming the multi-layer insole utilizes a pair of blanks for accepting the foot at different pressures to form negative impressions of the plantar side of the foot. The top and bottom layers of the multi-layer footwear insole are then formed from the negative impressions.

### CROSS-REFERENCE TO RELATED APPLICATION

The present application claims priority to, and the benefit of, U.S. Provisional Application No. 63/063,905, which was filed on Aug. 10, 2020 and is incorporated herein by reference in its entirety.

### BACKGROUND

The present invention generally relates to footwear inserts, and more specifically to a customizable multi-layer insert for footwear and method of manufacture. Accordingly, the present specification makes specific reference thereto. However, it is to be appreciated that aspects of the present invention are also equally amenable to other like applications, devices and methods of manufacture.

People with different shapes and sizes of feet may need different footwear accommodations to maintain comfort throughout a long day of wear. Aches and pains are common if footwear is unable to properly fit the wearer. Misalignment of the hips and spine can occur leading to extensive fatigue while wearing shoes that do not fit properly. Extensive pain caused by the poorly fitting footwear can lead to a decrease in motivation to exercise or time spent exercising. Additionally, anatomical compensation created by poorly fitting shoes can lead to long term or permanent injury and disability.

Foot pain is a common affliction that is often not due to underlying disease. A common cause is poorly fitting or constructed shoes that are not designed for prolonged use or specific tasks such as exercise. Additionally, the anatomy of the foot is highly individualized. Shoes are generally manufactured according to a template and are not generally customizable except for size. Most shoes do not take individualized foot anatomy into consideration in the shoe design. Injuries and medical issues, such as diabetes mellitus can further compound the problem of poorly fitting footwear. Other potential complications that cause foot pain include corns, calluses, bunions, warts, plantar fasciitis, obesity, pregnancy, and the like.

One solution is to get highly customized shoes every time shoes are needed which can be very expensive and will not work in every case. Shoe inserts are a nonprescription solution that can provide cushioning and support for some users. Inserts are typically made of materials like gel, plastic, or foam. Inserts fit into your shoes but are not custom-made for individual our feet. They also have to be cut to size by the user. They can provide some arch support or extra cushioning on the heel, around the toes, or for the entire foot. Inserts might make shoes more comfortable but aren't designed to correct foot problems or provide a long term solution. Orthotics are prescription medical devices that are worn inside the shoes to correct biomechanical foot issues such as problems with how a person walks, stands, or runs. Orthotics can also help with foot pain caused by medical conditions such as diabetes, plantar fasciitis, bursitis, and arthritis. However, these inserts are expensive and must be custom made.

Off the shelf insoles are the most popular way people attempt to alleviate foot pain. There are multiple factors to consider when selecting an insole including material, foot anatomy, sizing. Most insoles focus on just the type of foot arch and the type of footbed. This leaves a lot of anatomy unconsidered. Specifically, the individual musculature and tendon layout and detailed skeletal structure are not taken into account. The one size fits all insole approach may help ease one or two problems, but do not completely alleviate the overall condition.

In this manner, the improved footwear insert of the present invention accomplishes all of the forgoing objectives, thereby providing an easy solution to ill-fitting footwear. A primary feature of the present invention is the individual customization of multiple insert layers working together to ease aches and pains. The improved footwear insert of the present invention is capable of improving comfort by accommodating the muscles, tendons, ligaments, and skeletal structure of each foot. The improved footwear insert offers a simple way to align footwear with the shape of the user's foot to improve overall feel during a full day of wear.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a multi-layer footwear insole. The multi-layer footwear insole comprises a top layer. The top layer comprises a top surface and a bottom surface. The top layer further comprises a first impression portion formed into the top surface. The first impression portion is configured to conform to a user's muscle anatomy of a plantar side of a foot. The top layer further comprises a second impression portion. The second impression portion is configured to conform to a user's tendon anatomy of the plantar side of the foot. The second impression portion overlaps the first impression portion.

The multi-layer footwear insole further comprises a textured layer. The textured layer may be a gel or foam layer with a textured bottom. The textured layer may be attachable to the bottom surface of the top layer. An adhesive may be used to attach the textured layer to the bottom surface of the top layer.

The multi-layer footwear insole further comprises a bottom layer. The bottom layer comprises a top layer facing surface and a bottom surface. The textured layer may be attachable to the bottom surface of the bottom layer. The bottom layer further comprises a third impression portion. The third impression portion is formed into the top layer facing surface. The third impression portion is configured to conform to the user's skeletal anatomy of the plantar side of the user's foot. The bottom layer is positioned underneath the top layer when the multi-layer footwear insole is placed in footwear.

In an additional embodiment, the subject matter disclosed and claimed herein comprises a method of making a multi-layer footwear insole. The method comprises creating a negative impression of a plantar side of a foot in a first blank at a first pressure. Next, the method continues by creating a negative impression of the plantar side of the foot in a second blank at a second pressure. The first and second blanks are molds configured to retain the three dimensional anatomical shapes of the inserted foot. The negative impression formed in the first blank captures a user's muscle and tendon anatomy of the plantar side of the foot. The negative impression formed in the second blank captures the user's skeletal anatomy of the plantar side of the foot.

The method continues by forming a top layer of the multi-layer footwear insole from the negative impression in the first blank. The top layer comprises a top surface and a bottom surface. The top layer further comprises a first impression portion formed into the top surface. The first impression portion is configured to conform to a user's muscle anatomy of a plantar side of a foot. The top layer further comprises a second impression portion. The second impression portion is configured to conform to a user's tendon anatomy of the plantar side of the foot. The second impression portion overlaps the first impression portion. A textured layer may be added to the bottom surface of the top layer. The textured layer may be a gel or foam layer with a textured bottom attached with an adhesive.

The method continues by forming a bottom layer of the multi-layer footwear insole from the negative impression in the second blank. The bottom layer comprises top layer facing surface and a bottom surface. The textured layer may be attachable to the bottom surface of the bottom layer. The bottom layer further comprises a third impression portion. The third impression portion is formed into the top layer facing surface. The third impression portion is configured to conform to the user's skeletal anatomy of the plantar side of the user's foot. The method ends with combining the top and bottom layers into the multi-layer footwear insole.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of a multi-layer footwear insole of the present invention for insertion in footwear in accordance with the disclosed architecture.

FIG. 2 illustrates a perspective view of a top layer of the multi-layer footwear insole of the present invention in accordance with the disclosed architecture.

FIG. 3 illustrates a perspective view of a bottom surface of the top layer and a textured layer of the multi-layer footwear insole of the present invention in accordance with the disclosed architecture.

FIG. 4 illustrates a perspective view of a bottom layer of the multi-layer footwear insole of the present invention in accordance with the disclosed architecture.

FIG. 5 illustrates a perspective view of a footwear sole facing surface of the bottom layer of the multi-layer footwear insole of the present invention in accordance with the disclosed architecture.

FIG. 6 illustrates a method of forming a multi-layer footwear insole of the present invention for insertion in footwear in accordance with the disclosed architecture.

FIG. 7 illustrates a side view of a first blank for forming a negative impression a plantar side of a foot at a first pressure in accordance with the disclosed architecture.

FIG. 8 illustrates a side view of a second blank for forming a negative impression a plantar side of a foot at a second pressure in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a footwear insole built around a mold of the user's feet. The customer indents a clay foot mold which is sent to a manufacturer for creating custom insoles. The footwear insole is a multi-layer insole for shoes created from the custom mold of the wearer's foot. The impression from the clay molding allows the customization of insoles that aid in correcting foot placement, improving balance, reducing aches and pains, and other health benefits.

Each insole is comprised of multiple layers. A muscle and tendon layer indented with the shape of the wearer's foot muscles and tendons functions as a shock absorber. A textured bottom layer can also be applied. A skeletal layer can be included featuring a gel textured bottom. The layers work in conjunction to offer a more comfortable and effective insole, customized to a wearer's needs and preferences. The insoles may be applied to any type of footwear.

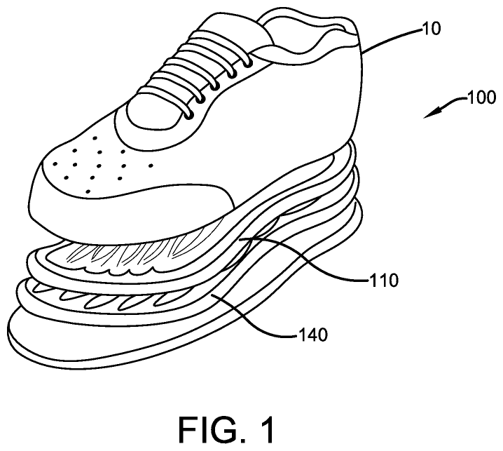

Referring initially to the drawings, FIG. 1 illustrates a multi-layer footwear insole 100. The multi-layer footwear insole 100 is customizable and is insertable into a variety of footwear 10, such as shoes, athletic footwear, boots, clippers, skates, or the like. The multi-layer footwear insole 100 may be manufactured from plastics, foam, gel, cork, rubber, open cell materials, combinations thereof, or the like. Once formed, the multi-layer footwear insole 100 is trimmable to customize the fit inside the footwear 10.

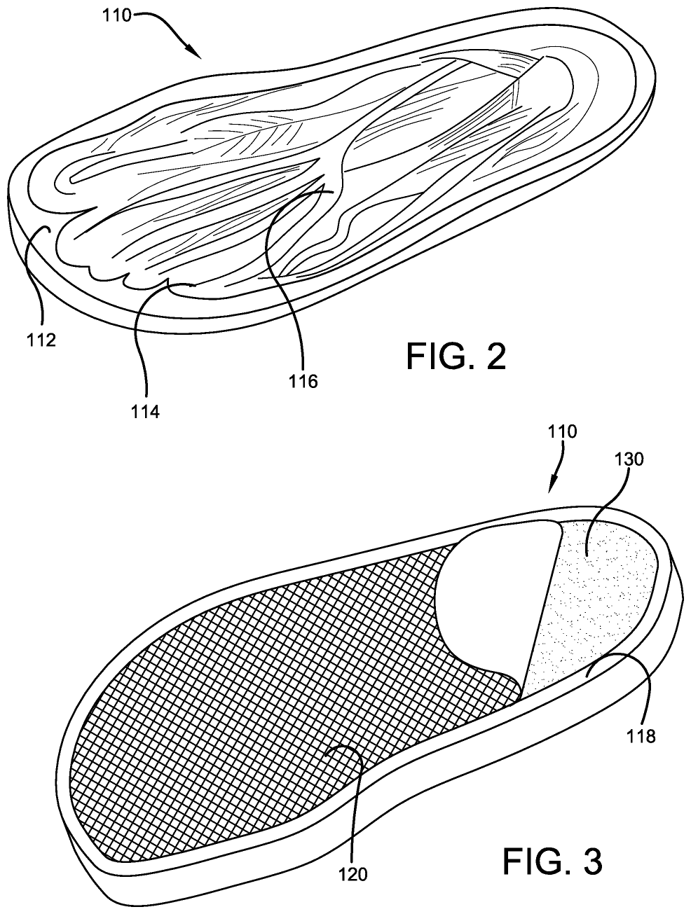

As illustrated in FIGS. 2 and 3, the multi-layer footwear insole 100 comprises a top layer 110. The top layer 110 is shock absorbent to cushion and support the muscles and tendons of a user's foot when pressure is applied by walking, running, jumping, or the like. The top layer 110 comprises a top surface 112 and a bottom surface 118. The top layer 110 further comprises a first impression portion 114 formed or pressed into the top surface 110. The first impression portion 114 is configured to conform to a user's muscle anatomy of a plantar side of a foot. The top layer 110 further comprises a second impression portion 116 formed or pressed into the top surface 110. The second impression portion 116 is configured to conform to a user's tendon anatomy of the plantar side of the foot. The second impression portion 116 overlaps the first impression portion 114.

As illustrated in FIG. 3, the multi-layer footwear insole 100 further comprises a textured layer 120. The textured layer 120 may be a gel or foam layer with a textured bottom. The textured layer 120 may be attachable to the bottom surface 118 of the top layer 110. The textured layer 120 may be separate from the top layer 110 or an adhesive 130 may be used to attach the textured layer 120 to the bottom surface 118 of the top layer 110. Alternatively, the textured layer 120 may be formed or pressed into the bottom surface 118 using heat or pressure.

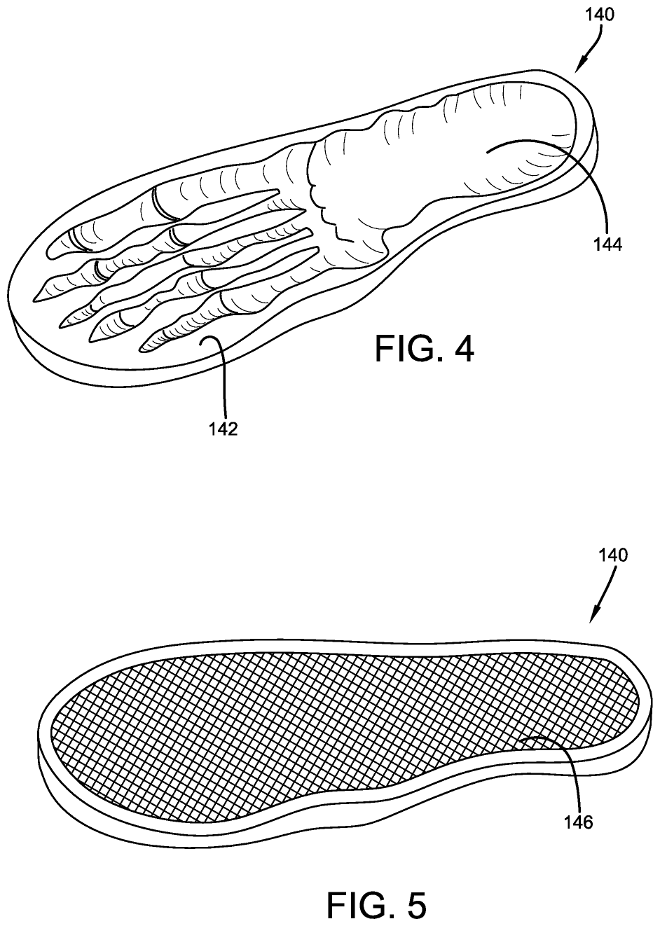

As illustrated in FIGS. 4 and 5, the multi-layer footwear insole 100 further comprises a bottom layer 140. The bottom layer 140 is shock absorbent to cushion and support the skeletal structure of a user's foot when pressure is applied by walking, running, jumping, or the like. The bottom layer 140 comprises a top layer facing surface 142 and a bottom surface 146. The bottom surface 146 may be textured. Alternatively, the textured layer 120 may be attachable to the bottom surface 146 of the bottom layer 140 in a similar manner as described for the top layer 110. The bottom layer 140 further comprises a third impression portion 144. The third impression portion 144 is formed into the top layer facing surface 142 of the bottom layer 140. The third impression portion 144 is configured to conform to the user's skeletal anatomy of the plantar side of the user's foot. The bottom layer 140 is positioned underneath the top layer 110 when the multi-layer footwear insole 100 is placed in footwear 10.

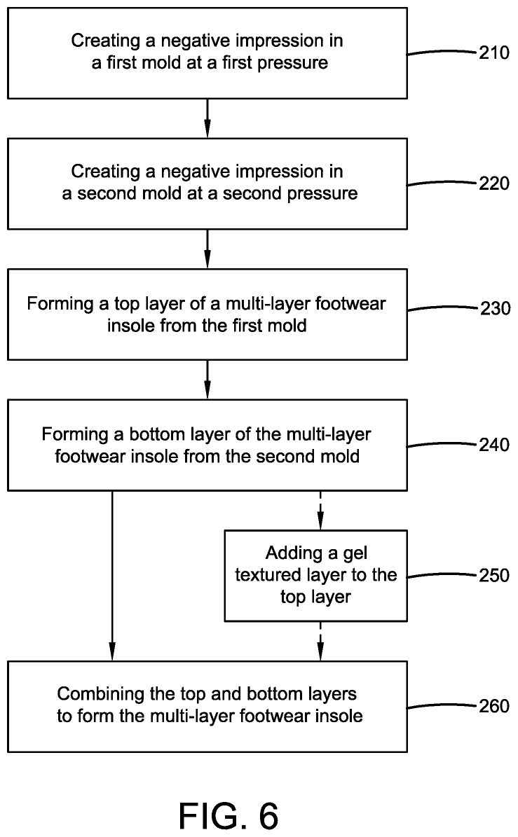

In an additional embodiment, FIGS. 6-8 illustrates a method 100 of making a multi-layer footwear insole 100. The method 200 comprises creating a negative impression 204 of a plantar side of a foot in a first blank 202 at a first pressure at 210 as a user inserts a foot into the first blank 202 and applies pressure. Next at 220, the method 200 continues by creating a deeper negative impression 208 of the plantar side of the foot in a second blank 206 at a second pressure as a user inserts a foot into the second blank 206 and applies pressure. The first pressure is lighter than the second pressure.

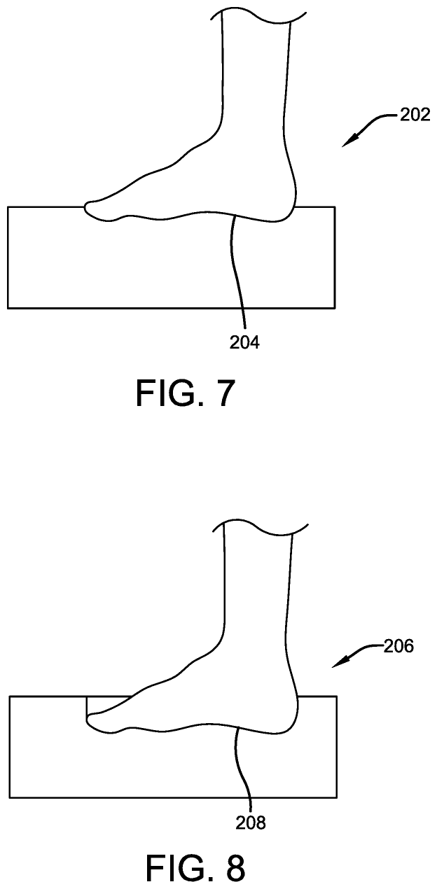

As illustrated in FIGS. 7 and 8, the first and second blanks 202 and 206 are molds configured to retain the three dimensional anatomical shapes of the inserted foot. The molds may be clay molds, wax molds, or molds of a different deformable material that will retain the shape of a negative impression once impressed. The negative impression 204 formed in the first blank 202 captures a user's muscle and tendon anatomy of the plantar side of the foot. The negative impression 208 formed in the second blank 206 captures the user's skeletal anatomy of the plantar side of the foot.

The method continues at 230 by forming a top layer 110 of the multi-layer footwear insole 100 from the negative impression 204 in the first blank 202. The top layer 110 comprises a top surface 112 and a bottom surface 118. The top layer 110 further comprises a first impression portion 114 formed or pressed into the top surface 110. The first impression portion 114 is configured to conform to a user's muscle anatomy of the plantar side of the foot. The top layer 110 further comprises a second impression portion 116 formed or pressed into the top surface 110. The second impression portion 116 is configured to conform to a user's tendon anatomy of the plantar side of the foot. The second impression portion 116 overlaps the first impression portion 114. The top layer 110 is formed using traditional insole manufacturing processes.

The method continues at 240 by forming a bottom layer 140 of the multi-layer footwear insole 100 from the negative impression 208 in the second blank 206. The bottom layer 140 comprises a top layer facing surface 142 and a bottom surface 146. The bottom layer 140 further comprises a third impression portion 144. The third impression portion 144 is formed into the top layer facing surface 142 of the bottom layer 140. The third impression portion 144 is configured to conform to the user's skeletal anatomy of the plantar side of the user's foot. The bottom layer 140 is formed using traditional insole manufacturing processes.

At 250, a textured layer 120 may be added to the top layer 110. The textured layer 120 may be a gel or foam layer with a textured bottom. The textured layer 120 may be attachable to the bottom surface 118 of the top layer 110. The textured layer 120 may be separate from the top layer 110 or an adhesive 130 may be used to attach the textured layer 120 to the bottom surface 118 of the top layer 110. Alternatively, the textured layer 120 may be formed or pressed into the bottom surface 118 using heat or pressure. Alternatively, the textured layer 120 may be attachable to the bottom surface 146 of the bottom layer 140 in a similar manner as described for the top layer 110.

The method ends at 260 as the bottom 140 and top 110 layers are combined to form the multi-layer footwear insole 100. The bottom layer 140 is positioned underneath the top layer 110 when the multi-layer footwear insole 100 is placed in footwear 10. The textured layer 120 will be sandwiched between the bottom 140 and top 110 layers or attached to the bottom surface 146 of the bottom layer 140 or both.

It is contemplated that the multi-layer footwear insole 100 and method 200 of making the multi-layer footwear insole 100 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-layer footwear insole comprising:
a top layer comprising a first impression portion and a second impression portion overlapping the first impression portion; and
a textured layer attachable to a bottom surface of the top layer.

2. The multi-layer footwear insole of claim 1, wherein the first impression portion conforms to a user's muscle anatomy of a plantar side of a foot.

3. The multi-layer footwear insole of claim 1, wherein the second impression portion conforms to a user's tendon anatomy of a plantar side of the foot.

4. The multi-layer footwear insole of claim 1, wherein the textured layer is attachable to the bottom surface of the top layer with an adhesive.

5. The multi-layer footwear insole of claim 1, wherein the textured layer is a gel layer with a textured bottom.

6. The multi-layer footwear insole of claim 1, wherein the multi-layer footwear insole is trimmable to fit inside a shoe.

7. The multi-layer footwear insole of claim 1, wherein the top layer is shock absorbent.

8. A multi-layer footwear insole comprising:
a top layer comprising a first impression portion and a second impression portion overlapping the first impression portion; and
a bottom layer comprising a third impression portion.

9. The multi-layer footwear insole of claim 8 further comprising a textured layer attachable to a bottom surface of the top layer.

10. The multi-layer footwear insole of claim 8 further comprising a textured layer attachable to a bottom surface of the bottom layer.

11. The multi-layer footwear insole of claim 10, wherein the textured layer is a gel layer with a textured bottom.

12. The multi-layer footwear insole of claim 8, wherein the first impression portion conforms to a user's muscle anatomy of a plantar side of a foot.

13. The multi-layer footwear insole of claim 12, wherein the second impression portion conforms to a user's tendon anatomy of the plantar side of the foot.

14. The multi-layer footwear insole of claim 8, wherein the third impression portion conforms to a user's skeletal anatomy of a plantar side of the foot.

15. The multi-layer footwear insole of claim 8, wherein the bottom layer is shock absorbent.

16. A method of making a multi-layer footwear insole comprising the steps of:
creating a negative impression of a plantar side of a foot in a first blank at a first pressure;
creating a negative impression of the plantar side of the foot in a second blank at a second pressure;
forming a top layer of the multi-layer footwear insole from the negative impression in the first blank;
forming a bottom layer of the multi-layer footwear insole from the negative impression in the second blank;
combining the top and bottom layers into the multi-layer footwear insole.

17. The method of claim 16 further comprising the step of adding a gel textured layer to the top layer.

18. The method of claim 16, wherein the top layer of the multi-layer footwear insole comprises a first impression portion and a second impression portion overlapping the first impression portion.

19. The method of claim 18, wherein the bottom layer comprises a third impression portion.

20. The method of claim 19, wherein the third impression portion conforms to a user's skeletal anatomy of the plantar side of the foot.
